(19) United States
(12) Patent Application Publication
(10) Pub. No.: US 2006/0044589 A1
(43) Pub. Date: Mar. 2, 2006

(54) Printing device and method for printing

(76) Inventor: Shuichi Nakagawaji, Yokohama-shi (JP)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/926,389

(22) Filed: Aug. 26, 2004

(51) Int. Cl. G06K 15/00

(52) U.S. Cl. 358/1.14

(57) ABSTRACT

A printing device for printing print information sent from a computer via a communication line includes: a print information receiving unit for receiving via the communication line encrypted print information which has been generated by encrypting the print information in the computer using a password; a password receiving unit for receiving via the communication line an encrypted password which has been generated by encrypting the password in the computer; a password decryption unit for obtaining the password by decrypting the encrypted password received by the password receiving unit; a print information decryption unit for obtaining the print information by decrypting using the password the encrypted print information received by the print information receiving unit; and a printing unit for printing the print information obtained by the print information decryption unit on a predetermined print medium.

### BACKGROUND OF THE INVENTION

1. Field of the Invention

The present invention relates to a printing device and to a method for printing which are suitable for printing information to be printed which is sent from a computer via a communication line.

2. Description of Related Art

In one system, a dedicated printer or an all-in-one printing machine which is capable of functioning as a printer, fax machine, copier, and/or other machines is connected to a computer via a network, e.g., a LAN (local area network) or the Internet, or a communication line (hereinafter, such a network or line is collectively referred to as “communication line”), to transmit data to be printed (hereinafter referred to as “print data” or “print information”) via the communication line. In another system, a storage device, e.g., a hard disk, is mounted on a dedicated printer or an all-in-one printing machine. In such a system, information sent from a computer is stored in the storage device so that the data can be printed repeatedly or can be printed at a later time.

In the above-mentioned systems, information leakage on a communication line sometimes poses a concern. For addressing this issue, various encryption techniques for encrypting information transmitted on a communication line have been proposed. One example of such techniques is described and illustrated on pages 9 to 11 and in FIG. 1 of Japanese Laid-open Patent No. 2002-318535. In the system taught in JP 2002-318535, print data is divided into graphic information and text information before being transmitted. Then the data is decrypted in a receiving computer, and is printed on a printer.

Additionally, techniques for preventing information, particularly one stored in a storage device, from being printed by an unauthorized user on a printer which is shared by multiple users have been proposed. One example of such techniques is described and illustrated on page 4 and in FIG. 4 of Japanese Laid-open Patent No. H11-301058. In the system taught by JP H11-301058, security information, e.g., passwords, as well as data to be printed, are sent from a computer to a printer. The security information is then received by the printer, and authenticity of the security information is confirmed by the printer when the print data is printed.

Even though print data transmitted on a communication line is encrypted in the system described in JP 2002-318535, the encrypted print data is decrypted in a computer. In addition, this technique is not designed for a system in which a printer is shared by multiple users.

In contrast, in the system taught by JP H11-301058, access permissions for printing or deleting print data stored in a printer are managed using security information. Therefore, this system is not directed to leakage of print data or security information when they are being transmitted via a communication line.

### SUMMARY OF THE INVENTION

The present invention has been conceived in light of the above-described situation, and an object thereof is to provide a printing device and a method for printing which can prevent information leakage when the data is being transmitted to the printing device which is connected to a computer via a communication line. Another object of the present invention is to provide a printing device and a method for printing which can prevent leakage of print data as well as security information associated with the print data. Yet another object of the present invention is to provide a printing device and a method for printing which can enhance protection of print data received by a printing device when the data is being output.

To solve the problems mentioned above, a first aspect of the present invention provides a printing device for printing print information sent from a computer via a communication line. The printing device includes: a print information receiving unit for receiving via the communication line encrypted print information which has been generated by encrypting the print information in the computer using a password; a password receiving unit for receiving via the communication line an encrypted password which has been generated by encrypting the password in the computer; a password decryption unit for obtaining the password by decrypting the encrypted password received by the password receiving unit; a print information decryption unit for obtaining the print information by decrypting using the password the encrypted print information received by the print information receiving unit; and a printing unit for printing the print information obtained by the print information decryption unit on a predetermined print medium.

With this configuration, the print information (print data) is encrypted in the computer using the password, and then the encrypted data is decrypted in the printing device. Accordingly, leakage of the print information on the communication line can be prevented. Furthermore, since the password is transmitted after it is encrypted, leakage of the password information on the communication line can also be prevented.

A second aspect of the present invention provides a printing device for printing print information sent from a computer via a communication line. The printing device includes: a print information receiving unit for receiving via the communication line encrypted print information which has been generated by encrypting the print information in the computer using a password; a print information storage unit for storing the encrypted print information received by the print information receiving unit; a password input unit for receiving an input of a password; a print information decryption unit for obtaining the print information by decrypting the encrypted using the password the print information stored in the print information storage unit; and a printing unit for printing the print information obtained by the print information decryption unit on a predetermined print medium.

With this configuration, the print information is encrypted in the computer using the password, and is then temporarily stored in the storage device of the printing device. The stored print information is printed after it is decrypted. Upon decryption of the printing information in the printing device, the password is input into the printing device. Therefore, leakage of print information on the communication line can be prevented. Furthermore, protection of print data received by the printing device when the data is being output can be improved.

According to a third aspect of the present invention, a security level for encrypting of one of the password and the print information is selectable among a plurality of different ranks. With this configuration, a password assigning process or time required for the process can be optimized according to a priority of the print information, for example.

According to a fourth aspect of the present invention, the password is one of a plurality of passwords which have been preset, and the passwords have been assigned to a plurality of groups. The password is at least one password assigned to a first group of the plurality of groups. The print information decryption unit is capable of decrypting the encrypted print information which has been encrypted using the password of at least one password assigned to the first group of the plurality of groups, using one of: the password of the passwords assigned to the first group, and any of at least one password assigned to a second group of the plurality of groups. With this configuration, printing can be performed using other passwords belonging to the same group, for example. Alternatively, a hierarchy among groups may be defined, and passwords belonging to an upper group can be used to print all of print information encrypted by passwords belonging to a lower group.

According to a fifth aspect of the present invention, the password has been selectably preset so that the password is selected by means of a predetermined operation on the computer, or so that the password is selected automatically. A password which is identical to the preset password has been selectably preset to the print information decryption unit so that the password is selectable by means of the predetermined operation, or so that the password is selected automatically. This makes provision of passwords easier.

According to a sixth aspect of the present invention, the password is associated with identification information of a specific user, and when a password is input, the password input unit accepts the entered password if the entered password coincides with the password associated with the identification information of the user. This can further enhance protection of print data received by the printing device when the data is being output.

According to a seventh aspect of the present invention, a key is used for encryption of the password and decryption of the encrypted password, and the key is stored in an encrypted form. This can further enhance protection of information when the data is being transmitted or printed out.

According to an eighth aspect of the present invention, the password is automatically generated and is varied based on one of time and a time interval. This can further improve protection of information when it is being transmitted. In addition, this makes operation simpler.

According to a ninth aspect of the present invention, the print information is compressed or converted into a predetermined format. This can help reduce size of data to be transferred over the communication line. Furthermore, selection of a proper compressing or transforming method can make deciphering of the data difficult; thus the protection of information during transmittal is further improved.

According to a tenth aspect of the present invention, the password is generated using biometric authentication of an operator. This can simplify operation for entering passwords or management of passwords. Also, protection for passwords can be further enhanced, and security breaches due to leakage of passwords can be prevented.

An eleventh aspect of the present invention provides a method for printing print information sent by a computer via a communication line. The method includes the steps of: receiving encrypted print information which has been generated by encrypting the print information in the computer using a password; receiving via the communication line the encrypted password which has been generated by encrypting the password; decrypting the encrypted password received during the step of receiving the encrypted password to obtain the password; decrypting the encrypted print information received during the step of receiving the print information to obtain the print information; and printing the print information obtained during the step of encrypting the encrypted print information on a predetermined print medium.

A twelfth aspect of the present invention provides a method for printing print information sent by a computer via a communication line. The method includes the steps of: receiving encrypted print information which has been generated by encrypting the print information in the computer using a password; storing the encrypted print information received during the step of receiving the print information; accepting the password which is entered; decrypting using the password the encrypted print information stored during the step of storing encrypted print information; and printing the print information obtained during the step of encrypting the encrypted print information on a predetermined print medium.

### BRIEF DESCRIPTION OF THE DRAWINGS

FIG. 1 is a schematic diagram depicting a printing system having the printer 3 according to the present invention; and

FIG. 2 is a block diagram depicting an example of printer 3 shown in FIG. 1.

### DETAILED DESCRIPTION OF THE INVENTION

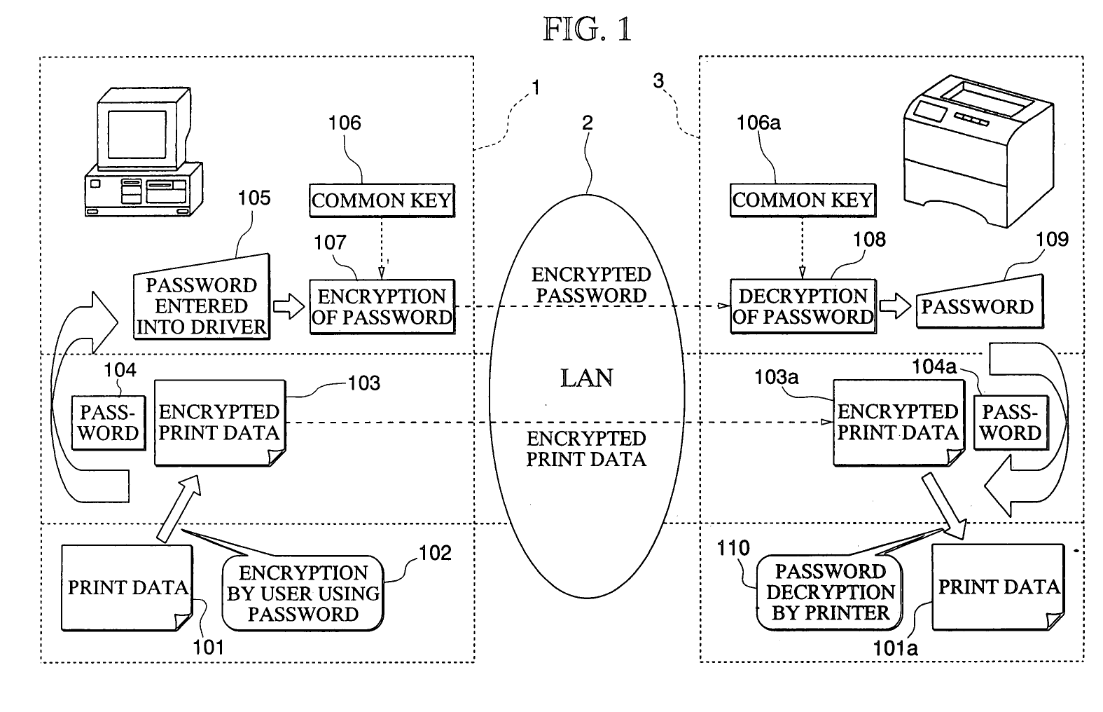

Preferred embodiments of the present invention will now be described with reference to the accompanying drawings. FIG. 1 is a schematic diagram depicting a configuration of a printing system having a printer 3 according to one embodiment of the present invention, and flow of information within this system. In FIG. 1, a computer 1 is connected to the printer 3 via a LAN 2. The computer 1 includes a central processing unit (CPU), a random access memory (RAM), a storage device, e.g., hard disk, a display, a keyboard, a mouse, and a communication device. The computer 1 is configured to execute application programs, e.g., word processing and picture drawing programs, under the control of any of well-known operating systems (OSs). Furthermore, printer driver software which controls the printer 3 under the control of the operating system is installed in the computer 1.

The printer 3 communicates with the operating system of the computer 1 via the LAN 2 using the predetermined protocol, and prints print data 101a on a predetermined print medium. The printer 3 may be, for example, a color or monochrome page printer or ink-jet printer. In this example, the printer 3 supports multiple page description languages (PDLs), languages for controlling printers, in various formats, and is capable of printing the print data 101 written in any of the supporting PDLs. The printer 3 can also print the print data 101 written in other file formats, and such formats are not limited to, but may be Portable Document Format (PDF), Graphics Interchange Format (GIF), Tag Image File Format (TIFF). The printer 3 may support a compressed format for TIFF and other formats.

A flow of process for printing the print data 101 using the printer 3 will now be described. A user creates a document using an application program, e.g., word processing or picture drawing program, on the computer 1, and outputs this data as a file in any of the file format described above to the printer 3. In this example, the print data 101 is output in PDF or TIFF format. The print data 101 is temporarily stored in the storage device of the computer 1.

The user then executes a well-known encryption program to provide any password 104 to the print data 101, and encrypts and compresses the print data 101 (Process 102). An encrypted print data 103 is generated by this operation. The user then instructs a printer driver to print the encrypted print data 103, for example, by dragging and dropping a file icon of the encrypted print data 103 onto an icon (or a shortcut) of the printer driver. In response, the printer driver displays a predetermined input window, prompting the user to enter the password 104 which was used for generating the encrypted print data 103. Once the user enters the password 104 (Process 105), the password 104 obtained by the printer driver is encrypted with the common key cryptography (or secret key cryptography) using a common key 106 as a key (Process 107). The encrypted print data 103 and the encrypted password are sent to the printer 3 via the LAN 2 by the printer driver.

The printer 3 then receives the encrypted print data 103 as well as the encrypted password via the LAN 2 (the received print data will be referred to as “encrypted print data 103a”). The printer 3 decrypts the encrypted password using the common key 106a which is identical to the common key 106 used by the printer driver of the computer 1 (Process 108). The decrypted password, password 104a, which is identical to the password 104, is stored in the printer 3 (Process 109). The printer 3 decrypts the encrypted print data 103a using the password 104a to generate a decrypted print data 101a which is identical to the print data 101 (Process 110). The printer 3 then prints the print data 101a on the predetermined print medium.

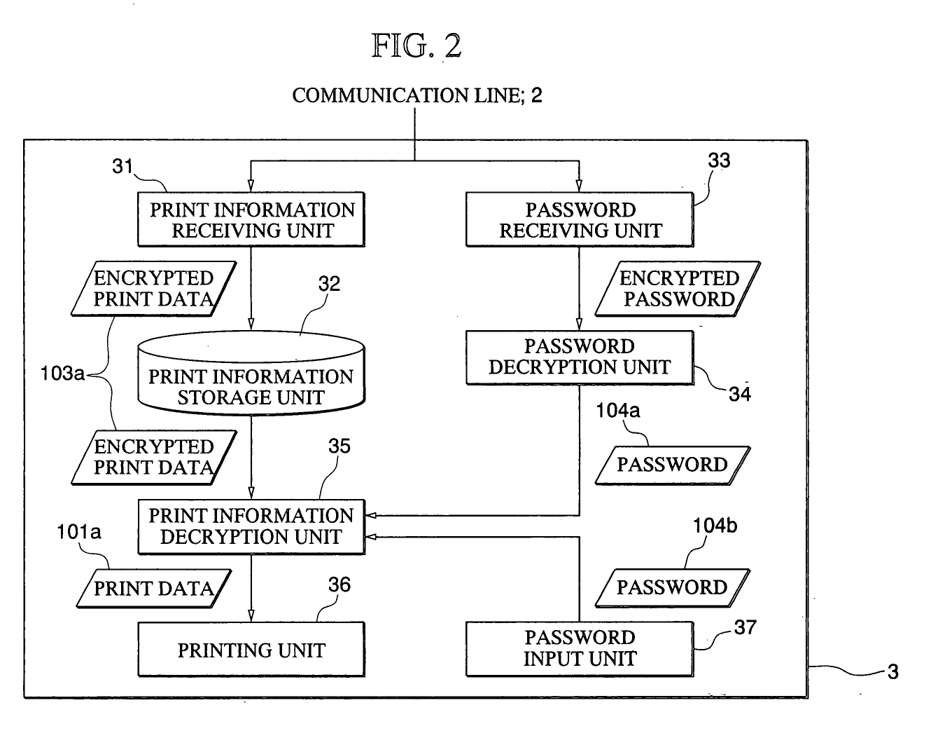

One example of the flow of data according to this embodiment has been described. An example of a configuration of the printer 3 will now be described with reference to FIG. 2.

FIG. 2 is a block diagram depicting one example of a configuration of the printer 3 shown in FIG. 1, illustrating each function of the printer 3. The printer 3 includes a central processing unit (CPU), a random access memory (RAM), a storage device, e.g., an electrically erasable programmable read-only memory (EEPROM) or a hard disk, an input interfacing device, a display, a communication device, and a print engine. The printer 3 executes a program stored in the nonvolatile storage device, e.g., EEPROM, on the CPU, processes data received from the computer 1, and controls a paper feed mechanism and the print engine so that the print data is printed on the predetermined print medium, e.g., paper.

A print information receiving unit 31 receives via a communication line (the LAN 2) the encrypted print data 103 which was generated by encrypting the print data 101 in the computer using the predetermined the password 104. The encrypted print data 103a received by the print information receiving unit 31 is stored in a print information storage unit 32 which includes a storage device, e.g., a hard disk.

A password receiving unit 33 receives via the communication line (the LAN 2) the encrypted password which was generated by encrypting the password 104 by the printer driver in the computer 1. A password decryption unit 34 then decrypts the encrypted password received by the password receiving unit 33 to obtain the password 104a. Upon decryption, the common key 106a (shown in FIG. 1) is used, and this common key 106a is identical to common key 106 which was used by the printer driver.

Using the password 104a, a print information decryption unit 35 decrypts the encrypted print data 103a which was received by the print information receiving unit 31 and has been stored in the print information storage unit 32 to obtain the print data 101a. The print data 101a obtained by the print information decryption unit 35 is printed on the predetermined print medium by a printing unit 36 which includes a print engine.

The user can print the encrypted print data 103a which is stored in the print information storage unit 32 at a later time by selecting specific data which the user would like to print, and entering a password associated with this data using a password input unit 37. The password input unit 37 includes an interfacing unit (e.g., a numeric keypad) and a display. In this example, the print information decryption unit 35 encrypts the encrypted print data 103a using the password 104b which was entered via the password input unit 37 and is identical to the password 104a. The print data 101a obtained by the print information decryption unit 35 is then printed by the printing unit 36.

Although it has been described that the encrypted print data 103 is generated in the computer 1 using a well-known encryption program in the system of FIG. 1, a system in which encryption and other processes are handled by a single component, e.g., the printer driver, may be possible. More specifically, if a user selects the printer 3 as a printer which the user uses to print a document in a word processing application, the printer driver may prompt the user to enter a password. The printer driver also encrypts print data 101 using the entered password to generate encrypted print data 103, in addition to generating a encrypted password.

Means for encrypting passwords included in the computer 1 are not limited to a printer driver, but may be any printer control software or hardware other than a printer driver. Examples of such printer control software are: (1) printer drivers; (2) application software which supports a graphical user interface (GUI); (3) printer control languages (PCL), e.g., the page description language (PDL) and printer job language (PJL); and (4) other programs for generating passwords. As an example of such hardware, (5) application-specific integrated circuits (ASICs) and other integrated circuits may be used. In the case in which (1) or (2) is used, a user may provide any desired password used for encryption on a GUI. In the case in which (3), (4), or (5) is used, passwords may be encrypted according to a command or algorithm which has been incorporated into the password encryption means. Passwords used by the password encryption means may have been preset (for example, into the program or circuit of (3), (4), or (5)), or may be given automatically based on a predetermined condition, or may have been provided by the user using (1) or (2).

Furthermore, security levels used for encrypting passwords or print data (in Process 102 or 107) may be selectable among a plurality of ranks. For example, the number of code bits used for encryption may be selectable in a single encryption algorithm. Alternatively, various encryption algorithms may be selectable, and the various encryption techniques may be classified into several ranks according to security levels, and may be presented to a user for selection.

Furthermore, a plurality of passwords 104 having different access permissions may be assigned to a plurality of groups, and the groups may be preset into the printer driver or the printer 3. It is assumed that a plurality of passwords are registered to Group A and Group B. In the case in which one of the passwords belonging to Group A is used for encryption, decryption can be carried out using the same password in Group A as the one used for the encryption, and any of the passwords in Group B. In this example, the selected password is not used during encryption; rather, it is converted into a different password assigned to each group.

Furthermore, a password may be selectably preset among predetermined passwords so that a password of the password may be selected by means of a predetermined operation on the printer driver, or may be selected automatically. In addition, a password which are identical to the one preset in the printer driver may be selectably preset in the print information decryption unit 35 (Process 108) so that the password may be selected by means of a predetermined operation, or may be selected automatically. In other words, a plurality of passwords are preset in the printer driver so that the preset passwords can be used upon encryption or decryption. More specifically, when the printer driver is started and a user is prompted to enter a password, one or more passwords are selectably displayed, for example. Once the user select one of the passwords, the selected password is transferred to a encryption program. Alternatively, one password may be generated automatically by the printer driver, and may be transferred to an encryption program.

Furthermore, identification information (ID) about a specific user may be associated with a password of the user. In this case, the password input unit 37 shown in FIG. 2 may receive the identification information of the user in addition to a password, and may accept the password only when the password coincides with a password which the identification information of the user is related to.

The keys 106 and 106a used for encrypting passwords or decrypting encrypted passwords may be encrypted by another encryption process, and may be stored in the computer 1 (or a data area controlled by the printer driver), or the information storage unit 32 of the printer 3.

Furthermore, if the password 104 is automatically generated in the computer 1, passwords generated may be varied based on time or a time interval according to a predetermined algorithm.

Furthermore, passwords may be biometric information generated by means of biometric authentication of an operator, and the biometric information may be input into the computer 1 or the printer 3.

The present invention is not limited to a dedicated printer, but may be an all-in-one printing machine which also functions as a fax machine and a copier.

Furthermore, the communication line may be a wired line or wireless. Although it is illustrated in FIG. 1 that one computer, one network, and one printer form the system, multiple units may be included in the system for each component. The computer is not limited to a desktop-type or notebook-type personal computer, but may be other types of terminal, such as a personal digital assistance or a mobile telephone.

The present invention prevents information leakage when data to be printed (print data) is being transmitted from a computer which is connected to a printing device via a communication line. Also, leakage of security information of print data as well as the print data itself can be prevented. Protection of print data when print data received by a printing device is being output can be improved.

While preferred embodiments of the invention have been described and illustrated above, it should be understood that these are examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A printing device for printing print information sent from a computer via a communication line, comprising;
a print information receiving unit for receiving via the communication line encrypted print information which has been generated by encrypting the print information in the computer using a password;
a password receiving unit for receiving via the communication line an encrypted password which has been generated by encrypting the password in the computer;
a password decryption unit for obtaining the password by decrypting the encrypted password received by the password receiving unit;
a print information decryption unit for obtaining the print information by decrypting using the password the encrypted print information received by the print information receiving unit; and
a printing unit for printing the print information obtained by the print information decryption unit on a predetermined print medium.

2. A printing device for printing print information sent from a computer via a communication line, comprising;
a print information receiving unit for receiving via the communication line encrypted print information which has been generated by encrypting the print information in the computer using a password;
a print information storage unit for storing the encrypted print information received by the print information receiving unit;
a password input unit for receiving an input of a password;
a print information decryption unit for obtaining the print information by decrypting the encrypted using the password the print information stored in the print information storage unit; and
a printing unit for printing the print information obtained by the print information decryption unit on a predetermined print medium.

3. The printing device according to claim 1, wherein a security level for encrypting of one of the password and the print information is selectable among a plurality of different ranks.

4. The printing device according to claim 2, wherein the password is one of a plurality of passwords which have been preset, the passwords having been assigned to a plurality of groups, the password being at least one password assigned to a first group of the plurality of groups, and the print information decryption unit is capable of decrypting the encrypted print information which has been encrypted using the password, using one of: the password of the passwords assigned to the first group, and any of at least one password assigned to a second group of the plurality of groups.

5. The printing device according to claim 1, wherein the password has been selectably preset so that the password is selected by means of a predetermined operation on the computer, or so that the password is selected automatically.

6. The printing device according to claim 5, wherein a password which is identical to the preset password has been selectably preset to the print information decryption unit so that the password is selected by means of the predetermined operation, or so that the password is selected automatically.

7. The printing device according to claim 2, wherein the password is associated with identification information of a specific user, and when a password is input, the password input unit accepts the entered password if the entered password coincides with the password associated with the identification information of the user.

8. The printing device according to claim 1 wherein, a key is used for encryption of the password and decryption of the encrypted password.

9. The printing device according to claim 8 wherein, the key is stored in an encrypted form.

10. The printing device according to claim 1, wherein the password is automatically generated.

11. The printing device according to claim 10, wherein the generated password is varied based on time.

12. The printing device according to claim 1, wherein the print information is compressed into a predetermined format.

13. The printing device according to claim 1, wherein the print information is converted into a predetermined format.

14. The printing device according to claim 1, wherein the password is generated using biometric authentication of an operator.

15. A method for printing print information sent by a computer via a communication line, comprising the steps of:
receiving encrypted print information which has been generated by encrypting the print information in the computer using a password;
receiving via the communication line the encrypted password which has been generated by encrypting the password;
decrypting the encrypted password received during the step of receiving the encrypted password to obtain the password; and
decrypting the encrypted print information received during the step of receiving the print information to obtain the print information; and
printing the print information obtained during the step of encrypting the encrypted print information on a predetermined print medium.

16. A method for printing print information sent by a computer via a communication line, comprising the steps of:
receiving encrypted print information which has been generated by encrypting the print information in the computer using a password;
storing the encrypted print information received during the step of receiving the print information;
accepting the password which is entered;
decrypting using the password the encrypted print information stored during the step of storing encrypted print information; and
printing the print information obtained during the step of encrypting the encrypted print information on a predetermined print medium.

17. The printing device according to claim 8, wherein the key is a key used in common key cryptography.
